(19) United States
(12) Patent Application Publication
(10) Pub. No.: US 2010/0274654 A1
(43) Pub. Date: Oct. 28, 2010

(54) METHOD AND SYSTEM FOR WIRELESS INTERNET PAYMENT USING MOBILE TERMINAL

(76) Inventor: Wang Seok LEE, Seoul (KR)

Correspondence Address: Jason Y. Pahng and Associates, LLC, 12178 Bridgend Run, Fairfax, VA, 22030, US

(21) Appl. No.: 12/428,484

(22) Filed: Apr. 23, 2009

(51) Int. Cl. G06Q 20/00; G06Q 30/00

(52) U.S. Cl. 705/14.26; 705/40; 705/26

(57) ABSTRACT

Provided are a method and system for wireless Internet payment using a mobile terminal through which payment is made through a wireless Internet while information regarding a payer is not released. Specifically, the wireless Internet payment system includes a participating store server providing an online shopping mall, a mobile terminal of a payer selecting information regarding a product to be purchased from among products handled by the online shopping mall through the wireless Internet and transmitting the information to the participating store server, and a payment server processing online payment of the product in connection with the participating store server and the mobile terminal, and the method embodies the wireless Internet payment system. Thus, payment is made while information regarding the payer is not released to the participating store such as the shopping mall, and thus the release of personal information online is prevented.

### BACKGROUND OF THE INVENTION

1. Field of the Invention

The present invention relates to a method and system for wireless Internet payment using a mobile terminal, and more particularly, to a method and system for wireless Internet payment using a mobile terminal through which payment is made so that personal information regarding a payer is not released to a participating store when a payer pays for a product or service purchased through wireless Internet.

2. Description of the Related Art

In recent times, problems such as the release of personal information when a payer pays for a product or service purchased online, have emerged as serious social problems.

When personal information is released online, examples of crimes using the released personal information may include false impersonation, shifting of fees, emotional distress due to privacy violation, subscription to a website without permission, a sale of member information, and serious crimes such as kidnap or murder. That is, crimes using the released personal information include crimes in relation to property and personal attacks on an individual as well as basic crimes such as fraudulent use of personal information.

Generally, in order to purchase a product from an Internet shopping mall, the payer has to provide personal information such as the payer's citizen registration number, name, address, phone number or occupation to the Internet shopping mall while subscribing to the Internet shopping mall.

In order to select a product or contents and make a payment after subscribing to the Internet shopping mall, the payer has to provide information regarding the payment means such as a credit card.

In this case, when personal information is released by a worker employed by an Internet website managing the personal information, members and payers providing their personal information may be injured due to the release of the personal information.

In addition, some websites may not construct or maintain an adequate security system, and may not manage personal information of members in a trustworthy manner. Thus, personal information to be protected by the websites may be released to hackers.

### SUMMARY OF THE INVENTION

The present invention provides a method and system for wireless Internet payment using a mobile terminal through which a payment is made while information regarding a payer is not provided to a participating store providing an Internet shopping mall.

According to an aspect of the present invention, there is provided a method of wireless Internet payment using a mobile terminal, performed by a wireless Internet payment system including: a participating store server providing an online shopping mall; a mobile terminal of a payer selecting information regarding a product to be purchased from among products handled by the online shopping mall through a wireless Internet, and transmitting the information regarding the product to the participating server; and a payment server processing online payment of the product in connection with the participating store server and the mobile terminal of the payer, the method including transmitting first identification information used to identify the product to the mobile terminal through the wireless Internet, wherein the transmitting is performed by the participating store server; transmitting second identification information used to identify the product, payment amount information of the product, and participating store information used to identify the online shopping mall, to the payment server, wherein the transmitting is performed by the participating store server; transmitting the first identification information and payment means information regarding a payment means to the payment server, wherein the transmitting is performed by the mobile terminal; when the first identification information and the second identification information are identical to each other, processing online payment of the product by using the first identification information, the second identification information, the payment amount information, the payment means information, and the participating store information, wherein the processing is performed by the payment server; and generating payment result information of the online payment, and transmitting the payment result information to the mobile terminal and the participating store information, wherein the generating and transmitting are performed by the payment server, wherein the online payment may be processed so that personal information of the payer is not released.

According to another aspect of the present invention, there is provided a computer readable recording medium having recorded thereon a program for executing the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a wireless Internet payment system according to an embodiment; and

FIG. 2 is a block diagram of a wireless Internet payment system according to another embodiment.

### DETAILED DESCRIPTION OF THE INVENTION

Hereinafter, the present invention will be described in detail by explaining exemplary embodiments of the invention with reference to the attached drawings.

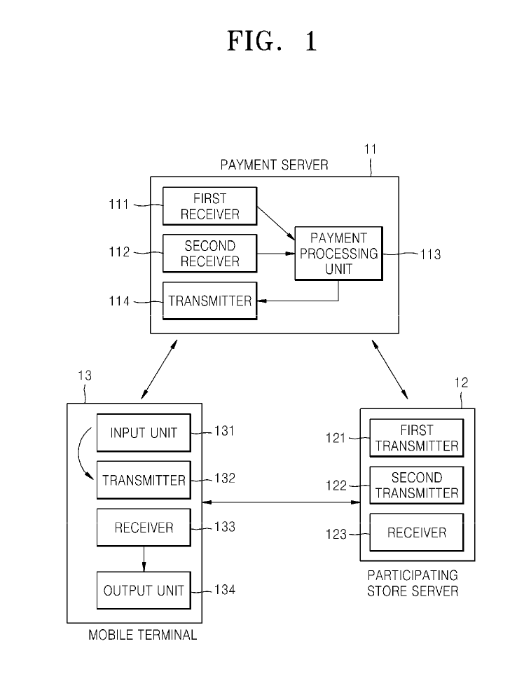

FIG. 1 is a block diagram of a wireless Internet payment system according to an embodiment. The wireless Internet payment system according to the present embodiment includes a payment server 11, a participating store server 12, and a mobile terminal 13.

The participating store server 12 is a server performing communication and is used to at a participating store. The participating store server 12 provides an online shopping mall dealing in tangible products such as material objects, intangible products such as video contents or music, and services through wireless Internet.

The mobile terminal 13 may perform communication through wireless Internet, may exchange data with the participating store server 12 through wireless Internet, and may purchase products or services. The mobile terminal 13 selects a product to be purchased from an online shopping mall provided by the participating store server 12, and transmits information regarding the selected product to the participating store server 12 using web browser which is built in the mobile terminal 13.

The mobile terminal 13 is used for payer payment. Examples of the mobile terminal 13 may include a mobile phone, a personal communication service (PCS) terminal, a personal digital assistant (PDA), and a lap top computer performing communication through wireless Internet.

The mobile terminal may communicate with the payment server 12 using the wireless communication such as mobile telecommunication and wireless internet. The payment server 12 may communicate with the participating store server 12 using the wire communication.

In FIG. 1, the participating store server 12 includes a first transmitter 121, a second transmitter 122 and a receiver 123.

The first transmitter 121 transmits first identification information that is used to identify the product, to the mobile terminal 13. When a payer selects a tangible or intangible product, or a service on an Internet website of an online shopping mall provided by a participating store, and requests to start a payment procedure, the product refers to a product that is determined to be subject to payment. Also, the product refers to the purchasing deal itself that is determined to be subject to request of payment.

For example, a consumer determines to purchase a predetermined product and requests to start a payment procedure with an online shopping mall of the participating store server 12, and then the first transmitter 121 transmits the first identification information formed by combining numbers and letters which are used to identify a deal regarding a product to be purchased, to the mobile terminal 13 that is the consumer's wireless Internet terminal.

The second transmitter 122 transmits second identification information used to identify the product, payment amount information regarding a payment amount, and participating store information used to identify the participating store, to the payment server 11.

The second identification information is information used to identify the product that is determined to be subject to payment, like the first identification information. When the consumer determines to purchase a predetermined product and requests to start a payment procedure, the first identification information and the second identification information are generated identically and simultaneously.

The payment amount information is information indicating an amount to be paid by a payer (that is, a purchaser) to the participating store during the deal.

The participating store information is identification information that is registered by the payment server 11 according to participating stores, so as to identify to whom an amount is to be paid by the payer. That is, when a consumer wants to purchase a product at a predetermined participating store, the participating store information corresponds to a code indicating the participating store selling the product.

The participating store information may be previously given to the participating store by the payment server 11, and may be stored in the payment server 11 and the participating store server 12.

The receiver 123 receives information regarding the product, and receives payment result information regarding the result of online payment, from the payment server 11.

The payment result information is information indicating whether payment has been successfully made by using payment means. When payment has been successfully made by the payment means, the payment result information may indicate that payment has been successfully made.

When payment has failed, the payment result information may indicate that payment has not been made. When payment has failed, the payment result information may include reasons for failure, or may not include any reasons. For example, the reasons for failure may include exceeding an upper credit card limit, or incorrectly inputting a credit card number or check card number.

In this case, payment result information received by the receiver 123 of the participating store server 12 may include only information indicating whether payment has been successfully made without reasons for failure. Since reasons for failure may be related to personal information of the payer, the reasons for failure do not have to be transmitted to the participating store.

On the other hand, payment result information received by a receiver 133 of the mobile terminal 13 from the payment server 11 may include reasons for failure in addition to information indicating whether payment has been successfully made. For example, when the reasons for failure may be incorrectly inputting a credit card number, or exceeding an upper credit card limit, and a payer may newly input another credit number after checking the reasons for failure, and thus payment may be successfully made. When payment may be successfully made in such a way, the receiver 123 may receive payment result information indicating that payment has been successfully made.

The payment result information may be output on a screen of the mobile terminal 13 at a point of time desired by a user.

The mobile terminal 13 performs communication through the wireless Internet so as to order a product or a service from an online shopping mall provided by the participating store server 12, and receives the first identification information that is used to identify the product, from the first transmitter 121 of the participating store server 12.

Referring to FIG. 1, the mobile terminal 13 includes an input unit 131, a transmitter 132, the receiver 133, and an output unit 134.

The receiver 133 receives the first identification information from the participating store server 12.

The payment means may be a credit card or check card of the payer, or a gift certificate of which an identification number may be input. Payment means information includes information regarding the payment means selected by the payer in order to pay for the product. For example, when the payment means is a credit card, the payment means information may include the kind and validity term of the credit card, a credit card number, and a password of the credit card.

The payment means information may be manually or automatically input by the input unit 131.

That is, the payer may input the payment means information by selecting payment means through a key board or touch screen included in the mobile terminal 13, or by manually inputting the payment means.

The payer may previously input and store the payment means information in the mobile terminal 13, or alternatively, may manually input the payment means information to the mobile terminal 13 after the first identification information is received by the mobile terminal 13. In addition, the payer may download and store the payment means information in a universal subscriber identity module (USIM) or storage means included in the mobile terminal 13.

The inventor of the present invention may pre-select a method from among the above methods, by which the payment means information is stored or input in the mobile terminal 13, or alternatively, a payer or user may voluntarily determine the method.

The transmitter 132 transmits the first identification information and the payment means information regarding the payment means, to the payment server 11.

In addition, the transmitter 132 may further transmit payer information related to the payer that may be used to select advertising data, to the payment server 11.

The payer information may be information regarding a payer's sex, age range, residential district, hobbies and special talents, but excludes a payer's citizen registration number or name through which the payer's identity may be released. The payer information may be used to select advertising data by the payment server 11 for target advertising.

The payer information together with the first identification information and the payment means information may also be transmitted to the payment server 11, or alternatively, may be previously transmitted to the payment server 11, separately from the first identification information and the payment means information.

The receiver 133 receives the payment result information regarding the result of online payment of the product, from the payment server 11. The payment result information is information regarding the result of online payment for the product, performed by the payment server 11.

In addition, the receiver 133 receives advertising data from the payment server 11. The advertising data may include voice data, text messages, moving picture or flash data, and may be used to inform the public of a participating store, a product or service handled by the participating store, regional news, national news, or the like.

The receiver 133 may receive the advertising data together with the payment result information, or alternatively, may previously receive the advertising data, before the payment result information is received.

The output unit 134 may output the payment result information, and may also output the advertising data received by the receiver 133. The output unit 134 may include any device for outputting images and sounds, such as a display device and speaker.

A point of time at which advertising data is output is set by the payer or the inventor of the present invention. The advertising data may be output before the payment result information is output.

For example, when the receiver 133 completes receipt of the payment result information while the output unit 134 outputs the advertising data, the output unit 134 may stop outputting the advertising data and then may output the payment result information, or alternatively may output the payment result information after output of the advertising data is completed.

When the advertising data is output by the mobile terminal 100 of the payer before the payment result information is output, the payer may wait for completion of payment while viewing advertising without getting bored during the payment processing procedure.

The mobile terminal 13 may be set regarding whether to output the advertising data. That is, the output unit 134 may output the advertising data only when the mobile terminal 13 is set by the payer to output the advertising data.

The output advertising data may be output any time when the payer wants to see the advertising data again when the advertising data is stored in the mobile terminal 13. When a discount coupon regarding an object being advertised is included in the advertising data, the payer may use the discount coupon by re-outputting the advertising data.

The mobile terminal 13 may store details regarding outputting of the advertising data together with the payment amount information, the payment means information and the participating store information. The details regarding the outputting of the advertising data may include one or more of information regarding an output date of the advertising data, information indicating whether the advertising data is output, and the output advertising data.

When the advertising data is output while the payment is proceeding or after payment completion, the transmitter 132 may transmit the details regarding the outputting of the advertising data to the payment server 11. The payment server 11 may use the details regarding the outputting of the advertising data in order to accurately calculate an advertising cost.

The payment server 11 performs online payment in connection with the participating store server 12 and the mobile terminal 13. For example, the payment server 11 may be a server managed by a financial institution or a payment agency.

The payment server 11 includes a first receiver 111, a second receiver 112, a payment processing unit 113, and a transmitter 114.

The first receiver 111 receives the first identification information used to identify the product and the payment means information regarding payment means to pay the payment amount, from the mobile terminal 13.

The second receiver 112 receives the second identification information used to identify the product, the payment amount information regarding the payment amount, and the participating store information used to identify the participating store receiving the order.

The payment processing unit 113 allows the payment amount that is identified by the first identification information and the second identification information to be paid by the payment means. That is, the payment processing unit 113 checks whether the first identification information and the second identification information are identical to each other, then derives a corresponding online payment that is identified by the first identification information and the second identification information, and checks whether the deal that is subject to payment is identical to the ordered product.

Online payment processing means that the product is paid for by the payment means and the participating store identified from the participating store information is finally paid. The amount to be paid and the payment means are derived from the payment amount information and payment means information which are received from the participating store server 12.

The transmitter 114 transmits the payment result information regarding the result of the online payment to the mobile terminal 13 and the participating store server 12.

The payment server 11 may manage the advertising data that is provided by the mobile terminal 13. As such, target advertising that is appropriate to characteristics of the payer or participating store may be achieved by managing the advertising, and a portion of the advertising cost is given as a monetary benefit to the payer who has viewed the advertising.

The transmitter 114 transmits the advertising data to the mobile terminal 13 when the first identification information and the second identification information are identical to each other. The advertising data may be transmitted during payment. When the advertising data has been received from the payment server 11 during the payment, the mobile terminal 13 outputs the advertising data in real time.

The advertising data may be previously transmitted by the transmitter 114 prior to payment. When the advertising data is previously received from the payment server 11, the mobile terminal 13 may store the advertising data, and may output the stored advertising data during the payment.

The first receiver 111 receives the payer information regarding the payer from the mobile terminal 13 for target advertising that is appropriate to the characteristics of the payer. The payer information is managed and stored in connection to a number of the mobile terminal 13.

The payment processing unit 113 selects the advertising data to be transmitted to the transmitter 114 by using one or more of the information regarding the payer, information regarding the participating store identified by using the participating store information, and information regarding a payment day or time.

For example, when the participating store is a store selling mobile phones, the payment processing unit 113 may select the advertising data regarding a new mobile phone.

The payment server 11 may previously store the participating store information, and may store the payment result information regarding the result of online payment.

The payment server 11 stores the information regarding the payer, the advertising data, and information regarding a classification criterion of the advertising data. The classification criterion of the advertising data includes information regarding age groups of advertising objects, a target area, a time zone for advertising, a product or service to be advertised, an advertising period, or the like.

The payment server 11 may store information regarding the number of times or date at which the transmitter 114 transmits the advertising data to the mobile terminal 13, or may store the details regarding the outputting of the advertising data that has been received by the first receiver 111 from the mobile terminal 13.

The payment server 11 provides a portion of an advertising cost to the payer by using the information during an advertising period or after the advertising period is terminated. The monetary benefit of the payer may be realized through a reduction in communication fees or various kinds of points, mileage, or discount coupons.

Hereinafter, a method of wireless Internet payment according to another embodiment will be described. The method of wireless Internet payment is performed by a wireless Internet payment system. The function of the wireless Internet payment system is materially the same as that of the wireless Internet payment system of FIG. 1, and thus a description thereof will not be repeated here.

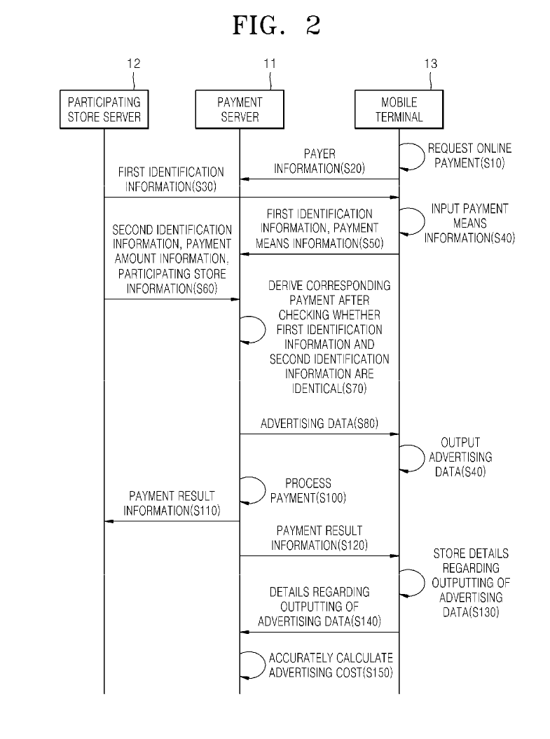

FIG. 2 is a flow chart of a method of wireless Internet payment according to an embodiment.

First, a payer connects with an online shopping mall of the participating store server 12 through wireless Internet of the mobile terminal 13, selects a product to be purchased from among products handled by the online shopping mall, and then requests to start an online payment procedure (operation S10).

The mobile terminal 13 transmits payer information related to the payer that may be used to select advertising data, to the payment server 11 (operation S20). The payer information may be information regarding a payer's sex, age range, residential district, hobbies and special talents, but excludes a payer's citizen registration number or name through which the payer's identity may be released.

The participating store server 12 transmits the first identification information that is used to identify the product, to the mobile terminal 13 when the payer requests to start a payment procedure (operation S30).

The mobile terminal 13 receives the first identification information that is used to identify the product from the participating store server 12 (operation S30), and then inputs the payment means information regarding payment means used to pay for the product (operation S40).

The mobile terminal 13 transmits the received first identification information and the input payment means information to the payment server 11 (operation S50). The payment means information may be input by selecting payment means through a key board or touch screen included in the mobile terminal 13, or by manually inputting the payment means. Alternatively, payment means information that is previously stored may be transmitted to the payment server 11. The inventor of the present invention may pre-select a method from among the above methods, by which the payment means information is input and transmitted, or alternatively, a payer or a user may voluntarily determine the method.

The participating store server 12 transmits the second identification information, the payment amount information, and the participating store information to the payment server 11 (operation S60). Although operation S60 is performed after performing operation S30 in FIG. 2, operations S60 and S30 may be simultaneously performed for faster payment processing.

The payment server 11 determines whether the first identification information and the second identification information are identical to each other, and then derives a corresponding online payment that is identified by the first identification information and the second identification information (operation S70). In this case, when the first identification information and the second identification information are not identical, the process is terminated.

The payment server 11 transmits the advertising data to the mobile terminal 13 (operation S80), and the mobile terminal 13 outputs the advertising data received from the payment server 11 (operation S90).

The advertising data may include voice data, text messages, moving picture or flash data, and may be used to inform the public of a participating store, a product, regional news, national news, or the like. A point of time at which advertising data is output is set by the payer or the inventor of the present invention. The advertising data may be output before the payment result information is output.

The payment server 11 may select the advertising data voluntarily and may transmit the advertising data to the mobile terminal 13. Alternatively, the payment server 11 may derive and transmit the advertising data according to a predetermined rule. In this case, the payment server 11 derives the advertising data by using one or more of information regarding the product, information regarding the payer, information regarding an online shopping mall identified by the participating store information, and information regarding a payment day or time, and transmits the derived information to the mobile terminal 13.

The payment server 11 processes the online payment that is derived by the payment amount information, the participating store information and the payment means information, which are identified by the first identification information and the second identification information (operation S100).

The payment server 11 transmits the payment result information to the participating store server 12 and the mobile terminal 13 after the payment processing is completed (operations S110 and S120). The mobile terminal 13 and the participating store server 12 may wait until the payment result information is received, and may output the payment result information.

A point of time at which the advertising data is transmitted or received, or output may not be limited to the above embodiments, and may be determined by the payer or the inventor of the present invention. That is, the payment server 11 may transmit the advertising data to the mobile terminal 13 at a point of time that is previously set. The output advertising data may be stored in the mobile terminal 13, and may be output any time when the payer wants to see the advertising data again even after the online payment processing is completed.

The mobile terminal 13 may store the details of outputting of the advertising data together with the payment amount information, the payment means information and the participating store information. The details of outputting of the advertising data may include one or more of information regarding an output date of the advertising data, information indicating whether the advertising data is output, and information regarding the output advertising data (operation S130).

When the advertising data is output while the payment process is proceeding or after payment completion, the mobile terminal 13 may transmit the details regarding the outputting of the advertising data to the payment server 11. The details regarding the outputting of the advertising data are used by the payment server 11 to accurately calculate an advertising cost (operations S140 and S150).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

As described above, according to the present invention, payment is made without providing personal information regarding a payer to a participating store. That is, since payment is made online without becoming a member or providing information regarding payment means such as a credit card, a payer may use an online shopping mall and may make payments safely without worrying about the release of personal information. Thus, reasons for the release of personal information online may be considerably reduced.

In addition, efficient target advertising using information regarding the participating store and the payer is provided to the payer, and an advertising effect is enhanced, and a portion of an advertising cost may be given as a monetary benefit to the payer who has viewed the advertising such that both advertiser and payer satisfaction can be improved.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A wireless Internet payment system using a mobile terminal, the system comprising:
a participating store server providing an online shopping mall;
a mobile terminal of a payer selecting information regarding a product to be purchased from among products handled by the online shopping mall through a wireless Internet, and transmitting the information regarding the product to the participating server; and
a payment server processing an online payment of the product in connection with the participating store server and the mobile terminal of the payer,
wherein the participating store server transmits first identification information used to identify the product to the mobile terminal through the wireless Internet, and transmits second identification information used to identify the product, payment amount information of the product, and participating store information used to identify the online shopping mall, to the payment server,
wherein the mobile terminal transmits the first identification information and payment means information regarding a payment means to the payment server,
wherein the payment server processes the online payment of the product by using the first identification information, the second identification information, the payment amount information, the payment means information, and the participating store information, and transmits payment result information of the online payment, to the mobile terminal and the participating store server, and
wherein the online payment is processed so that personal information of the payer is not released.

2. The wireless Internet payment system of claim 1, wherein the participating store server comprises:
a first transmitter transmitting the first identification information to the mobile terminal through the wireless Internet;
a second transmitter transmitting the second identification information and the payment amount information to the payment server; and
a receiver receiving the payment result information from the payment server.

3. The wireless Internet payment system of claim 1, wherein the mobile terminal comprises:
a receiver receiving the payment result information from the payment server and receiving the first identification information from the participating store server through the wireless Internet;
an input unit receiving the payment means information by using a shopping program embedded in the mobile terminal;
a transmitter transmitting the first identification information and the payment means information to the payment server; and
an output unit outputting the payment result information.

4. The wireless Internet payment system of claim 1, wherein the payment server comprises:
a first receiver receiving the first identification information and the payment means information from the mobile terminal;
a second receiver receiving the second identification information, the payment amount information, and the participating store information from the participating store server;
a processing unit processing the online payment with an online shopping mall identified by the participating store information by using the payment amount information and the payment means information, when the first identification information and the second identification information are identical to each other; and
a transmitter transmitting the payment result information to the mobile terminal and the participating store server.

5. The wireless Internet payment system of claim 3, wherein the payment server transmits advertising data to the mobile terminal when the first identification information and the second identification information are identical,
wherein the receiver of the mobile terminal receives the advertising data from the payment server, and
wherein the output unit of the mobile terminal outputs the advertising data received.

6. The wireless Internet payment system of claim 5, wherein the advertising data received is output until the payment result information is transmitted to the mobile terminal.

7. The wireless Internet payment system of claim 5, wherein the transmitter of the mobile terminal transmits payer information regarding a payer, which is used to select the advertising data, to the payment server, and
wherein the advertising data received is selected by the payment server by using at least one of information regarding the product, information regarding the payer, information regarding an online shopping mall identified by the participating store information, and information regarding a payment day or time.

8. The wireless Internet payment system of claim 5, wherein the transmitter of the mobile terminal transmits information regarding an output day or time of the advertising data, or information on whether to output the advertising data received, to the payment server, and
wherein the payment server receives the information regarding the output day or time, and accurately calculates an advertising cost according to the information regarding the output day or time.

9. A method of wireless Internet payment using a mobile terminal, performed by a wireless Internet payment system comprising: a participating store server providing an online shopping mall; a mobile terminal of a payer selecting information regarding a product to be purchased from among products handled by the online shopping mall through a wireless Internet, and transmitting the information regarding the product to the participating server; and a payment server processing online payment of the product in connection with the participating store server and the mobile terminal of the payer, the method comprising:
transmitting first identification information used to identify the product to the mobile terminal through the wireless Internet, wherein the transmitting is performed by the participating store server;
transmitting second identification information used to identify the product, payment amount information of the product, and participating store information used to identify the online shopping mall, to the payment server, wherein the transmitting is performed by the participating store server;
transmitting the first identification information and payment means information regarding a payment means to the payment server, wherein the transmitting is performed by the mobile terminal;
when the first identification information and the second identification information are identical to each other, processing online payment of the product by using the first identification information, the second identification information, the payment amount information, the payment means information, and the participating store information, wherein the processing is performed by the payment server; and
generating payment result information of the online payment, and transmitting the payment result information to the mobile terminal and the participating store information, wherein the generating and transmitting are performed by the payment server,
wherein the online payment is processed so that personal information of the payer is not released.

10. The method of claim 9, wherein the payment means information is received by the payer from the mobile terminal.

11. The method of claim 9, further comprising outputting the payment result information, wherein the outputting is performed by the mobile terminal.

12. The method of claim 9, further comprising:
when the first identification information and the second identification information are identical to each other, transmitting advertising data to the mobile terminal, wherein the transmitting is performed by the payment server; and
receiving and outputting the advertising data, wherein the receiving and the outputting are performed by the mobile terminal.

13. The method of claim 12, wherein the receiving and outputting of the advertising data are performed until the payment result information is transmitted to the mobile terminal.

14. The method of claim 12, wherein the transmitting of the advertising data comprises:
transmitting payer information regarding a payer, which is used to select the advertising data, to the payment server, wherein the transmitting is performed in the mobile terminal;
selecting the advertising data by using at least one of information regarding the product, information regarding the payer, information regarding an online shopping mall identified by the participating store information, and information regarding a payment day or time; and
when the first identification information and the second identification information are identical to each other, transmitting the selected advertising data to the mobile terminal, wherein the transmitting is performed by the payment server.

15. The method of claim 12, further comprising:
transmitting information regarding an output day or time of the advertising data, or information indicating whether to output the advertising data received, to the payment server, wherein the transmitting is performed by the mobile terminal; and
receiving the information regarding the output day or time, and accurately calculating an advertising cost according to the information regarding the output day or time, wherein the receiving and the calculating are performed by the payment server.

16. A computer readable recording medium having recorded thereon a program for executing the method of wireless Internet payment using a mobile terminal, performed by a wireless Internet payment system comprising: a participating store server providing an online shopping mall; a mobile terminal of a payer selecting information regarding a product to be purchased from among products handled by the online shopping mall through a wireless Internet, and transmitting the information regarding the product to the participating server; and a payment server processing online payment of the product in connection with the participating store server and the mobile terminal of the payer, the method comprising:
transmitting first identification information used to identify the product to the mobile terminal through the wireless Internet, wherein the transmitting is performed by the participating store server;
transmitting second identification information used to identify the product, payment amount information of the product, and participating store information used to identify the online shopping mall, to the payment server, wherein the transmitting is performed by the participating store server;
transmitting the first identification information and payment means information regarding a payment means to the payment server, wherein the transmitting is performed by the mobile terminal;
when the first identification information and the second identification information are identical to each other, processing online payment of the product by using the first identification information, the second identification information, the payment amount information, the payment means information, and the participating store information, wherein the processing is performed by the payment server; and
generating payment result information of the online payment, and transmitting the payment result information to the mobile terminal and the participating store information, wherein the generating and transmitting are performed by the payment server,
wherein the online payment is processed so that personal information of the payer is not released.
